(19) United States
(12) Patent Application Publication
(10) Pub. No.: US 2025/0378690 A1
(43) Pub. Date: Dec. 11, 2025

(54) METHOD AND SYSTEM FOR EXTRACTING INHERENT USER FEATURE USING ARTIFICIAL INTELLIGENCE

(71) Applicant: MoodMetrics AI, Bath (GB)

(72) Inventors: Kyle Jensen, Bath (GB); Daniel Schaub, River Heights, UT (US); Yatin Tanna, Kent (GB); Alex Golubeckis, Bath (GB); Luís Eduardo de Ávila Ballarati, Bath (GB); Kieran Kohtz, Bracknell (GB)

(73) Assignee: MoodMetrics AI, Bath (GB)

(21) Appl. No.: 19/189,489

(22) Filed: Apr. 25, 2025

Related U.S. Application Data
(60) Provisional application No. 63/638,861, filed on Apr. 25, 2024.

(51) Int. Cl. G06V 20/40; G06N 20/10; G06V 10/764; G06V 10/774; G06V 40/16; G06V 40/20; G10L 15/02; G10L 15/18; G10L 25/57; G10L 25/63; G10L 25/90

(52) U.S. Cl. CPC G06V 20/46; G06N 20/10; G06V 10/764; G06V 10/774; G06V 20/49; G10L 15/02; G10L 15/1807; G10L 25/57; G06V 40/176; G06V 40/20; G10L 25/63; G10L 25/90

(57) ABSTRACT

Disclosed is a computer-implemented method and system for training a subject-specific machine learning model to infer inherent subject features from recorded or live video data. The system preprocesses the visual and audio channels, converting audio to text, and employs multiple pre-trained extraction models to generate feature embeddings. Ground truth data is obtained to guide training, where weights are assigned to produce and combine predicted feature values. Model performance is optimized by minimizing error. The trained feature extraction models are deployed on an edge device, while the subject-specific model resides in the cloud. A lightweight edge model, derived via knowledge distillation and model compression, supports local inferencing with reduced reliance on cloud resources. Synchronization ensures iterative updates for sustained accuracy.

### FIELD OF THE INVENTION

The invention relates to a method and a system that uses artificial intelligence techniques for analyzing and predicting veracity, emotion, and other implicit content in audio and/or video data. More specifically, the method and system involve computer-based implementations that extract diverse features from the audio and/or visual content, train user-specific machine learning models using the extracted features and multi-level ground truth data, and utilize the trained models to infer characteristics of users' future audio and/or video content independently of ground truth data.

### BACKGROUND

Traditional methods of analyzing the behavior and truthfulness of individuals, particularly high-profile individuals such as governmental officials, corporate CEOs, and public speakers, have predominantly relied on human judgment and expertise. These methods include psychological analysis, body language interpretation, and basic lie detection techniques, which are often subjective and prone to error.

Furthermore, existing technologies in this space, such as polygraph tests and simple facial recognition software, focus on direct responses or superficial facial cues, which do not provide a comprehensive analysis of a person's deeper psychological states or the subtleties of their expressions and speech. These technologies also require the physical presence of the individual being analyzed and often generate results that can be contested in terms of accuracy and ethics.

The primary limitations of existing technologies include their inability to handle complex audio-visual data in real-time and their reliance on overt, rather than covert, indicators of emotion and truthfulness. Additionally, such technologies cannot integrate diverse data types (such as combining vocal tone analysis with micro expression detection) to provide a holistic assessment of the individual's credibility and emotional state.

There is a significant need for an advanced AI system capable of integrating and analyzing multiple sources of features extracted from audio-visual content to predict not only the veracity but also emotional states and other implicit content. Such a system would be invaluable in various high-stakes environments where understanding the underlying truths and emotions of individuals can impact decision-making processes significantly. Example applications include analyzing speeches by public figures to inform investment decisions, evaluating suspect interrogations to guide law enforcement strategies, and assessing company executives' presentations to adjust business strategies like production or marketing.

### SUMMARY

Various embodiments described herein addresses the technical challenges of existing technologies listed in the background section by employing sophisticated machine learning models that can analyze extensive and nuanced data sets, providing users with insights that are not only more accurate but also actionable in real-time scenarios. This enables a proactive approach in fields such as security, finance, and corporate strategy, ultimately leading to more informed and effective decision-making. Various embodiments are also applicable to the legal industry, the defense industry, market research, and politics.

In one general aspect, a computer-implemented method includes receiving, by a computing system with at least one processor, video data of a user, where the video data comprises both audio and visual data and is either recorded or live-streamed. The method further includes preprocessing, by a video data preprocessing pipeline executed by the computing system, the video data to separate the audio and visual data into independent data channels. This preprocessing involves extracting individual frames from the visual data, extracting an audio segments from the video data, and optionally converting the audio segments into textual data.

The method also includes inputting the video data into a plurality of pre-trained feature extraction machine learning models to generate multiple channels of feature embeddings. Additionally, the method comprises obtaining ground truth data associated with the inherent feature of the user, where the ground truth data is either historical ground truth data when the video data is recorded or estimated ground truth data when the video data is live-streamed.

The method further includes training a user-specific machine learning model based on the plurality of feature embedding channels and the ground truth data. The training process involves assigning weights to the plurality of feature embedding channels, generating multiple predicted values of the inherent feature of the user based on the feature embeddings, computing a weighted prediction of the inherent feature of the user using the assigned weights, and optimizing the model by adjusting the weights to minimize the error between the weighted prediction and the ground truth data.

The method also includes deploying the plurality of pre-trained feature extraction machine learning models and the trained user-specific machine learning model for inferencing the inherent user feature based on additional video data. The deployment process comprises deploying the pre-trained feature extraction machine learning models on an edge device to locally process video data and extract feature embeddings in real time, deploying the user-specific machine learning model on a cloud server to perform high-accuracy inferencing using feature embeddings received from the edge device, generating a lightweight version of the user-specific machine learning model using knowledge distillation and model compression, deploying the lightweight version on the edge device to enable localized inferencing before or without continuous reliance on cloud access, and synchronizing the lightweight version with the cloud-hosted user-specific machine learning model to maintain performance consistency.

Other embodiments of this method include corresponding computer systems, apparatus, and computer programs recorded on one or more computer storage devices, each configured to perform the described actions.

The method may incorporate one or more additional features. The pre-trained feature extraction machine learning models may include a first machine learning model for generating a textual content channel extracted from the audio data, a second machine learning model for extracting verbal speech pattern features from the audio data, and a third machine learning model for extracting visual features from the visual data. The first machine learning model may include a natural language processing model for generating textual content from the audio data. The second machine learning model may include a verbal feature extraction model to detect speech characteristics such as tone, voice prosody, pitch variations, stutters, speech rate, volume, and pauses. The third machine learning model may include a visual feature extraction model to analyze facial expressions, micro-expressions, physiological responses, eye tracking, pupil dilation, thermal imaging, and body movements.

The method may also include generating a predicted value of the inherent user feature based on different channels, including textual features, verbal speech features, and visual features. The ground truth data may include verified observations of the user's inherent feature in response to the video data. A Support Vector Machine (SVM) may be used as the user-specific model, where training includes creating multiple classes for the predicted inherent user feature in a high-dimensional feature space, assigning and adjusting weights to the feature embeddings, and finding a hyperplane that maximizes separation margins between classes in the high-dimensional space.

The inherent user feature inferred by the model may include credibility, authenticity, bias, veracity, or truthfulness. In another implementation, the video data includes recordings of the user's past speeches, with historical ground truth data capturing real-world outcomes following those speeches. For live video streams, the ground truth data may be derived from real-time market reactions measured by financial indices.

The training process may involve segmenting the video data into multiple video segments based on distribution patterns in the extracted feature embeddings and training the user-specific model to obtain multiple sets of weights corresponding to different segments, allowing the model to apply optimized weights dynamically.

During inferencing, the system may monitor, in real time, the value distribution pattern of the extracted feature embeddings while the video is playing, customize, in real time, the inference process by activating the appropriate set of weights based on detected distribution patterns, and adjust inference accuracy dynamically by synchronizing with real-time ground truth data.

The method may also involve obtaining multiple user-specific models trained for different users sharing similar characteristics, aggregating these models into a user-group-specific machine learning model, and deploying this group model to infer inherent user features across multiple users efficiently.

In one general aspect, a system includes one or more processors configured to receive video data of a user, where the video data includes one or both of audio and visual data. The system processes the video data through a plurality of pre-trained feature extraction machine learning models, obtains ground truth data based on whether the video is recorded or live-streamed, and trains a user-specific machine learning model. The training process includes assigning weights to extracted feature embeddings, generating a weighted prediction of the inherent user feature, and adjusting model parameters to minimize inference error.

The system further deploys the trained model for real-time inference using an edge-cloud hybrid architecture, ensuring efficient distribution of computational workload. Other embodiments include corresponding computer systems, apparatus, and software programs recorded on one or more storage devices.

### BRIEF DESCRIPTION OF THE DRAWINGS

FIG. 1 illustrates an example training process of the AI system for learning inherent user features in accordance with some embodiments.

FIG. 2 illustrates an example inferencing process of the AI system for learning inherent user features in accordance with some embodiments.

FIG. 3 illustrates an example high-dimensional feature space for learning inherent user features in accordance with some embodiments.

FIG. 4 illustrates a block diagram of an inherent user feature learning model, in accordance with some embodiments.

FIGS. 5A and 5B illustrate two examples of enhanced versions of the inherent user feature learning model, in accordance with some embodiments.

FIG. 5C illustrates an example architecture for deploying the inherent user feature learning model, in accordance with some embodiments.

FIG. 5D illustrates an example User Interface for presenting the predicted result of the inherent user feature learning model, in accordance with some embodiments.

FIG. 6 illustrates an example computing device in which any of the embodiments described herein may be implemented.

### DETAILED DESCRIPTION

Embodiments disclosed herein provide methods, systems, and apparatus associated with a sophisticated artificial intelligence system designed to analyze visual and audio data extracted from video sources, aiming to predict inherent characteristics such as underlying and often unspoken attributes of an individual, such as truthfulness, sincerity, emotional state, credibility, consistency, authenticity, bias, and veracity. This comprehensive system employs advanced techniques to extract and analyze a diverse array of features from both visual and audio modalities to assess and predict subtle human behaviors and emotional states.

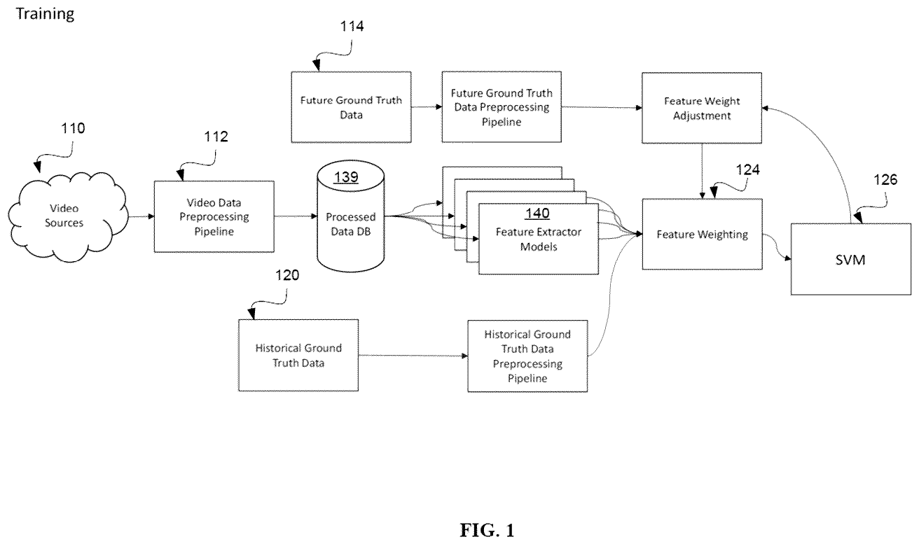

FIG. 1 illustrates an example training process of the AI system for learning inherent features of a subject or a user (e.g., a person, an animal, a robot, a digital persona, a group of individuals, or any entity capable of expressing behaviors via video or audio) in accordance with some embodiments. The components in FIG. 1 are for illustrative purposes only. Depending on the implementation, the training process may involve more, fewer, or alternative components.

The AI system may be trained based on video sources 110 that are recorded or live streams. This implies that training can be executed offline, online, or using a hybrid approach. The system's training regimen is of a supervised nature, thus necessitating the use of ground truth data as labels for the input video sources 110. The origin of this ground truth data may vary based on the chosen training approach.

For example, when employing pre-recorded training videos as video sources 110, historical ground truth data 120 is gathered for the purpose of training. This historical ground truth data 120 may include confirmed or verified instances of subject-inherent features subsequent to the video's recording. For instance, a video may feature an individual announcing a policy shift or unveiling new products or services, with the historical ground truth data 120 comprising subsequent realizations or non-realizations of the policies or delivery status of the products/services announced. Similarly, in a video featuring a statement pertinent to an inquiry, the corresponding historical ground truth data 120 may include the observed results of the inquiry following the statement. Since historical ground truth data 120 contains outcomes or consequences directly observed following the statements made in the videos, it is considered a reliable reflection of the actual subject-inherent attributes underlying the explicit features shown in the videos. Consequently, this historical ground truth data 120 serves as an effective tool for labeling training videos in terms of subject-inherent features.

As another example, when the video sources 110 encompass live streaming content featuring ongoing speeches, “observed” historical ground truth data may not be immediately available. Nevertheless, in such scenarios, future ground truth data 114 can be collected concurrently for training objectives. A common scenario might involve monitoring financial market responses to a speech that influences market dynamics. For example, should a Federal Reserve official issue a live announcement, real-time market responses—such as reactions reflected in the volatility index or other relevant indicators—may be obtained in real-time and utilized as “provisional” ground truth for the purposes of training. Examples of such “provisional” ground truth may include VIX index, also known as the Chicago Board Options Exchange (CBOE) Volatility Index, which measures the stock market's expectation of volatility based on options of the S&P 500 index. Several other volatility indexes are used around the world to measure market uncertainty and investor sentiment, such as VXN, VXD, etc. These indexes provide forward projection of volatility in different sectors and regions.

In some embodiments, the AI system trained online based on real-time video streams can also undergo later offline training when relevant observations (such as actual ground truth data) become available. For example, live video sources 110 utilized for online system training might be archived with a provisional label. Upon the acquisition of new information (such as observations of the actual effect or outcome of the speech), these video sources 110 can be retrieved, updated with definitive labels, and incorporated into subsequent offline training cycles. Therefore, a single video source 110 can serve both online and offline training processes at different times.

In some embodiments, the AI system comprises a two-tiered machine learning architecture. The initial tier consists of multiple pre-trained feature extraction models 140 tasked with processing the video stream 110 to capture and encode explicit features, including both spatial features (e.g., from individual frames) and temporal features (e.g., dynamic variations in subject behavior over time across continuous frames). Subsequently, the second tier involves a machine learning model 126 tailored to the subject, which deduces inherent subject features from the explicit features provided by the pre-trained feature extraction models 140. Training the AI system primarily focuses on this subject-specific machine learning model 126. While the pre-trained feature extraction models 140 are specifically designed to isolate the necessary explicit features, their configuration remains distinct and separate from the subject-specific model's training regimen that utilizes the video sources 110.

Referring back to the process illustrated in FIG. 1, the video source 110 may first go through a video data preprocessing pipeline 112 to generate multiple channels of input data, such as visual data, audio data, and text data.

The video data preprocessing pipeline 112 may first utilize digital processing techniques to separate the video source 110 into individual frames, which allows for the analysis of visual content.

Simultaneously, the audio segments are extracted from the video source 110 using digital signal processing tools.

Textual data extraction may follow the conversion of the audio content to text. This is achieved through Automatic Speech Recognition (ASR) technologies, which transcribe spoken words into written form.

After the subject's explicit features are extracted by the video data preprocessing pipeline 112 based on the video sources 110, these features are embedded into a processed Data DB 139 for storage and subsequent processing.

Separating different channels of information from the video sources 110 allow the system to extract the explicit features of the subject in the video stream 110 in parallel. Note that the most computation-intensive tasks are explicit feature extractions: by allowing processing the different channels of information in parallel, the overall performance of the system is significantly improved.

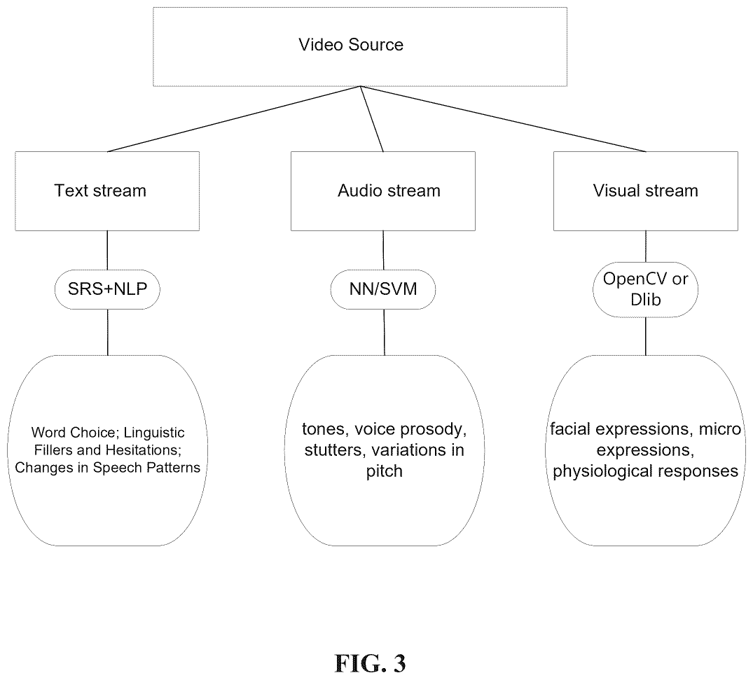

Next, the different channels of information may be fed to the corresponding feature extractor models 140. For instance, computer vision models may be applied to the video frames to identify and quantify a variety of visual elements such as facial expressions, micro-expressions, eye movements, pupil dilations, and body postures. More details are described in FIG. 3. For specialized data like thermal images, the video data preprocessing pipeline 112 may require integration with infrared-sensitive equipment and corresponding software for proper feature extraction. Thermal image may be only available when the subject making the speech is physically accessible by the infrared-sensitive equipment.

The feature extractor models 140 may further include an audio feature extraction model dissecting the audio channel to discern features like tone, pitch, volume, speech rate, and any occurrences of stutters or variations in prosody. More details are described in FIG. 3.

The feature extractor models 140 may further include a Natural Language Processing (NLP) model to analyze the textual data for linguistic content, which includes the assessment of word choice, sentence structure, and any indicative verbal patterns that may be linked to psychological states or behavioral intentions. More details are described in FIG. 3.

In practical applications, the explicit subject features extracted from the different visual, audio, and textual channels have distinct data formats, due to the diverse nature of the data and the specific methods used for their extraction.

For instance, visual features extracted from the visual stream generally results in quantitative metrics such as coordinates for facial landmarks, pixel intensities or extracted features like edge histograms, vectors indicating body movement, or matrices representing frame-by-frame changes. These features are usually derived using computer vision techniques and are often stored as numerical arrays or matrices, which provide detailed spatial and temporal information about visible characteristics.

Audio features, on the other hand, include spectral data like pitch, frequency components, and intensity, as well as temporal features such as speech rate and pause duration. Audio feature extraction tools output these features typically as vectors of spectral features or temporal patterns, where each element of the vector represents a specific attribute or a statistical summary of audio properties over a given time window.

Textual features extracted through speech-to-text technologies results in sequential data that captures linguistic and semantic properties. This can include word embeddings or frequency counts, n-gram models, or more complex embeddings like word vectors that encapsulate contextual usage patterns of words and phrases.

In a specific example, subject's facial features can be extracted as below. The process may begin with frame extraction, where individual frames are sampled at fixed intervals from the video feed. Extracting frames at predetermined intervals optimizes computational efficiency by reducing redundancy while preserving sufficient temporal data for analysis.

Once frames are extracted, the system may perform face detection on each frame to identify the location of the subject's face. Face detection may be achieved using an algorithm that identifies patterns corresponding to facial structures. The detected face regions may then be isolated and cropped for further analysis, ensuring that only relevant facial data is retained.

Following face detection, key frame selection may be implemented to refine the dataset by retaining only the most informative frames. The system may assess image quality parameters such as sharpness, brightness, and contrast and may apply an evaluation mechanism to assign a quality score to each frame. Based on these assessments, the system may retain the top-ranked frames for subsequent processing, thereby improving the reliability of feature extraction.

The next step may involve facial landmark detection, which identifies specific points of interest on the face, such as the eyes, nose, mouth, and jawline. The system may apply a landmark detection model to track and map facial features across multiple frames. This landmarking process enables the system to accommodate variations in facial orientation and expressions by dynamically adjusting to pitch, yaw, and roll angles, ensuring that facial feature extraction remains robust under different head positions and lighting conditions.

Once landmarks are identified, the system may extract feature vectors representing the subject's facial characteristics. A trained deep learning model may be applied to generate embeddings that capture distinct facial attributes. These embeddings may be normalized and averaged across selected frames to construct a comprehensive representation of the subject's facial features, ensuring consistency even in the presence of minor variations between frames.

To enhance usability, the extracted feature vectors may undergo post-processing for further analysis and classification. Techniques such as clustering, similarity mapping, or classification algorithms may be applied to compare extracted facial features against reference databases for identity verification or behavioral analysis. The processed feature data may then be stored for real-time decision-making or future retrieval, depending on the application requirements.

By implementing this structured approach, the system ensures efficient and accurate extraction of facial features from a sequence of video frames. This methodology enhances the reliability of facial analysis applications across various domains, including identity verification, subject authentication, and behavioral analysis in AI-driven inference systems.

In addition to extracting spatial features (visual, audio, textural features) from individual frames of the video source 110, the feature extractor models 140 may further include a temporal AI model using temporal feature extraction techniques to capture dynamic variations in subject behavior over time. For visual processing, a temporal convolutional network (TCN), recurrent neural network (RNN), or long short-term memory (LSTM) model may be employed to track time-dependent changes in facial expressions, micro-expressions, eye movements, pupil dilation patterns, and body gestures. Specifically, the temporal AI model is configured to determine metrics including but not limited to the rate of facial expression transitions, frequency and duration of micro-expressions, asymmetry in facial muscular movements, and subtle intermediate deformation patterns occurring between distinct emotional states.

For analyzing voice dynamics, the temporal AI model may employ audio feature extraction models enhanced by time-series processing techniques. These models compute temporal variations in prosody, characterized by quantifiable shifts in pitch frequency, amplitude intensity, spectral features, and voice timbre across consecutive time segments. The temporal analysis may leverage methods such as Short-Time Fourier Transform (STFT), Mel-Frequency Cepstral Coefficients (MFCCs), chroma features, wavelet transforms, dynamic time warping (DTW), moving averages, and sequential modeling using RNN. Additionally, the temporal AI model extracts and quantifies speech characteristics including speech rate variability, temporal patterns of pauses, and the incidence of speech irregularities such as stutters or hesitations.

Subsequently, the extracted temporal features from the visual and audio segments are synchronized using temporal alignment methods to generate a cohesive multi-channel time-series representation. Unlike conventional single-source temporal feature extraction, where time-dependent data originates from a uniform modality (such as continuous video frames or sequential audio samples), the current use case involves heterogeneous time-series data from multiple independent channels. Each channel (e.g., visual, audio, text) has distinct sampling rates, resolution constraints, and modality-specific distortions, requiring a specialized multi-modal alignment mechanism. In some embodiments, the system employs cross-modal synchronization techniques for aligning audio-prosodic variations with corresponding facial movements, and attention-based sequence alignment models to correlate spoken words with micro-expressions. The system may further integrate interpolation and temporal resampling techniques to normalize varying frame rates and ensure feature-level correspondence between disparate data streams.

In some embodiments, both the synchronized representation of the temporal features and the spatial features are subsequently processed by a hierarchical AI model architecture comprising at least two distinct tiers. In the first tier, a neural network-based temporal aggregation model receives multi-channel temporal and spatial data and is trained to identify and compress temporal and spatial patterns and dependencies. The output from this first-tier model includes refined temporal and spatial embeddings that represent behavioral trends over time. These temporal embeddings are then input into a second-tier classifier, e.g., an SVM, specifically trained to classify inherent subject attributes including emotional state, sincerity, credibility, consistency, authenticity, bias, and veracity.

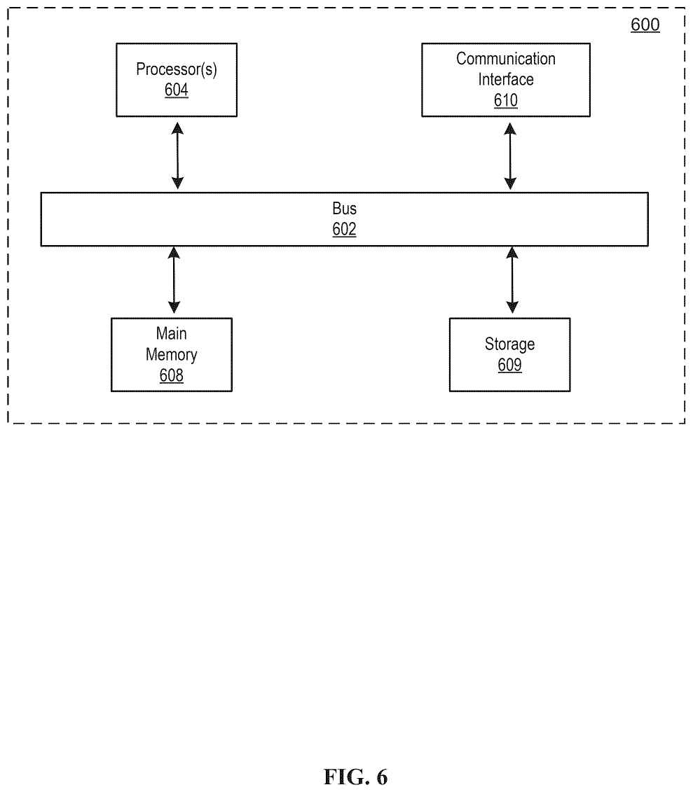

These heterogeneous data types will be used as input features of the subject-specific inherent feature learning model. In FIG. 6, a Support Vector Machine (SVM) 126 is used as an example of the subject-specific inherent feature learning model. In some embodiments, SVM is preferred over other models in this use case due to its stability and control, which ensure predictable and reliable outcomes crucial for critical decision-making processes. Additionally, SVMs offer superior interpretability, a valuable trait in environments where understanding the model's decision-making process is necessary. The capability of SVMs to effectively manage and incorporate boundaries prevents unreasonable outputs, further enhancing their suitability. Moreover, SVMs are adept at integrating and handling a diverse array of features from complex multimodal data sources, such as video and audio streams, making them an ideal choice for projects requiring robust and accurate predictive modeling across various data types.

There are several technical challenges in integrating the diverse feature formats as the input of the SVM 126. For example, different data types typically operate on different scales. For example, pixel values for images range from 0 to 255, whereas audio intensities or textual word counts might have a significantly different range.

To address the challenge of ensuring no single feature type dominates the Support Vector Machine (SVM) due to its scale, effective strategies such as scaling and quantization can be employed to standardize the diverse features. Scaling helps normalize the range of feature values across different modalities so that each feature type contributes equally to the decision-making process. In some embodiments, a Min-Max Scaling method may be applied to the incoming feature vectors, which rescales the feature values to a standardized range, e.g., 0 to 1 or −1 to 1.

In addition to scaling, Quantization may also be implemented as part of the feature preprocessing phase to reduce the model complexity and computation demands. In some embodiments, the AI system in FIG. 1 may be implemented in a portable device or in hardware-driven environments such as embedded systems in real-time applications. In these cases, quantization involves transforming continuous or high-resolution features into discrete values or lower-resolution equivalents, which can significantly speed up computation and reduce memory requirements.

Once standardization is complete, the SVM 126 operates by learning to assign weights to these features. The assignment of these weights is based on the relevance and significance of each feature in predicting the subject's inherent characteristics. In this context, the SVM 126 uses a training algorithm that optimizes these weights to maximize the margin between the classes in the feature space, which correspond to different values of the subject's inherent feature. In the simplest case, the subject's inherent feature is a binary value (true or false), thus the number of classes is two. In other more complicated cases, the subject's inherent feature may be multi-class or even continuous, such as emotional states (e.g., happiness, sadness, anger, fear, surprise, and disgust), spectrum of trustworthiness (e.g., multiple levels of trustworthiness), stress level (e.g., could be a continuous value), personality traits (e.g., different personalities). In these cases, the number of classes might be a large number greater than two.

Another significant technical challenge in implementing the SVM 126 arises from processing a large number of input features, i.e., the explicit features. With the input feature count exceeding four, the SVM 126 is tasked with delineating a hyperplane in a high-dimensional space, a concept that surpasses straightforward geometric interpretations readily understandable in lower dimensions and thus beyond human mental process capacity. As the number of features increases, so does the dimensionality of the space in which the SVM 126 operates, leading to elevated computational complexity and increased processing time. This increased complexity necessitates greater computational resources for both the training and inferencing phases. In certain scenarios, the explicit features fed into the SVM 126 for predicting the inherent feature could number in the tens, thirties, fifties, or even hundreds.

To control model complexity and avoid the need for a single SVM 126 to compute a complex hyperplane with high latency, a multi-tier machine learning architecture can be employed to efficiently reduce the number of input feature dimensions while preserving essential information.

In certain implementations, the model 126 might incorporate a first-tier model that identifies explicit feature distribution patterns and subsequently eliminates inconsequential or redundant explicit features. These refined features are then input into a second tier, which may include (1) an SVM equipped with various sets of weights tailored to different explicit feature distribution patterns, or (2) multiple SVMs each specifically trained to predict the subject's inherent features based on distinct explicit feature distribution patterns. This way, the second tier of models have a controlled number of input features, thereby simplifying the computational demands and enhancing the model's efficiency and effectiveness in accurately predicting inherent subject features.

For instance, the first tier of the model 126 may include a neural network trained to learn the relationship between the explicit feature distribution pattern and the insignificant or repetitive explicit features through the training process. In comparison to SVM, neural network is generally better suited to handle large datasets with many input features, primarily because of their deep learning architectures that can learn complex patterns and relationships in the data. This neural network at the first tier of model 126 may receive all explicit features, and assign different weights to the features, to identify and remove (deactivate) duplicate explicit features that contribute redundantly to the same dimension and eliminates those explicit features that are insignificant for a particular explicit feature distribution pattern.

For instance, in a video analysis, both audio analysis and textual transcripts might capture the same spoken words. For instance, the word “yes” could be identified as spoken softly through audio feature extraction (indicating a low confidence or hesitation) and appear in the textual data. In this case, the audio “yes” contains more information (including the tones) than the text “yes,” so the text “yes” would be considered as repetitive and/or insignificant, and be pruned out by the first-tier model. A more detailed example of such enhanced model is described in FIG. 6.

In other embodiments, ensembled method may be adopted to address the complexity issue of processing a large number of input features. Instead of relying on a single SVM 126, use an ensemble of leaf SVMs where each model in the ensemble is trained on a subset of the features or data. Each leaf SVM can make predictions based on features from respective channels (e.g., a first SVM processes the visual features, a second SVM processes the audio features, and a third SVM processes the text features), and then a meta-classifier or averaging method can be used to combine these predictions into the final value of the inherent subject feature.

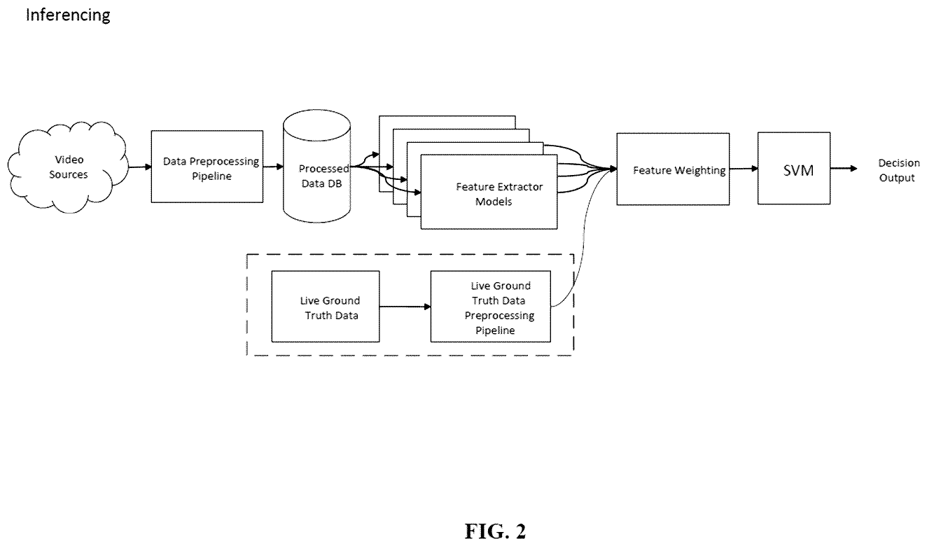

FIG. 2 illustrates an example inferencing process of the AI system for learning inherent subject features in accordance with some embodiments. As shown, the inferencing process in FIG. 2 is similar to the training workflow illustrated in FIG. 1, except that the inferencing process does not adjust the feature weight as the SVM.

In a typical inferencing process, a video source is obtained (either recorded or live) and goes through the data preprocessing pipeline to split into multiple channels of information. These channels of information may be fed into a group of feature extraction models for extracting the explicit features in the video source. These extracted features may then be assigned with different weights by the SVM to generate the predicted inherent feature of the subject. This inferencing process may be independent from any ground truth data.

During the inferencing process, several specific techniques may be implemented to improve the system's performance. For example the video source, whether recorded or live, often features an individual delivering a speech or announcement. Inferencing is executed in real time using sequentially received video clips from the source. After processing the first video clip for inferencing, live ground truth data (such as reactions reflected by the live VIX index) may become available in response to that clip. This live ground truth data can then be utilized to make immediate adjustments to the feature weights in the SVM for processing the next video clip. This pattern may continue until the video source is fully processed. This way, the feature weights within the SVM are dynamically modified in response to ongoing real-time ground truth data as the video continues.

FIG. 3 illustrates an example high-dimensional feature space for learning inherent subject features in accordance with some embodiments. As described above, the three mail streams of information extracted from the video source may include a text stream, an audio stream, and a visual stream.

In some embodiments, the extraction of various features from the visual stream, such as facial expressions, microexpressions, physiological responses, eye-tracking, pupil dilations, thermal imaging, and body movements, may require using advanced software and tools. An example process may be implemented as below.

Initially, the video stream may be of high-resolution to ensure that detailed features are accurately captured. The video is then converted into individual frames, typically involving decoding the video into images at a specific frame rate.

In some embodiments, facial detection algorithms are employed to identify faces within each frame using popular libraries such as OpenCV or Dlib, which provide pre-trained models for this purpose. After detecting the faces, facial landmark detection is applied to pinpoint critical points on the face, such as the corners of the mouth and eyes, using tools provided by libraries like Dlib. The movement of these facial landmarks is analyzed over time to classify various expressions and to capture microexpressions, which require high frame rate videos and sensitive algorithms due to their brief and subtle nature. Deep learning models trained on datasets such as FERA, CK+, or AffectNet may be used for this detailed analysis.

In some embodiments, the detection and tracking of eye movements and pupil dilations may use the above-identified landmarks. Algorithms like the Starburst Algorithm or gaze tracking libraries are utilized for this purpose, and specialized software that can measure changes in pupil size is employed, which demands high-resolution images to ensure accuracy.

In some embodiments, body movements may be analyzed using motion detection algorithms, supported by tools such as Pose Estimation libraries, including OpenPose and PoseNet, which detect human figures and track joint movements across frames. All data from these analyses—facial expressions, eye tracking, thermal imaging, and body movements—are integrated and synchronized to form a comprehensive profile of the subject's emotional and physiological state in real time.

The extraction of various features from the audio stream, such as tones, voice prosody, stutters, variations in pitch, speech rate, volume or intensity, and pauses, may involve a multi-step process that combines signal processing and machine learning techniques.

Initially, the audio stream may be isolated from the video using tools like FFmpeg, which extracts the audio track for further analysis. Following extraction, noise reduction techniques are applied to enhance the clarity of the audio by removing background noises, using methods such as spectral gating or more sophisticated deep learning-based denoising techniques.

The next phase may include audio feature extraction. Tools like Praat or libraries like LibROSA are utilized to analyze pitch (fundamental frequency) and intensity (loudness) contours, which are crucial indicators of prosody and emotional content. Additional analysis includes examining formant frequencies to characterize the speaker's voice quality, and assessing voice stability through features like jitter and shimmer. Speech rate and pauses are calculated by measuring the number of words or phonemes per unit time, and pauses are identified by detecting silent intervals within the speech. Furthermore, abnormalities such as stutters or repeated phrases are analyzed for temporal patterns and sudden changes in speech rhythm.

Similarly, text features extracted from the speech may offer insights into the speaker's psychological state, truthfulness, and cognitive load. By analyzing word choice and frequency, patterns can be identified that suggest whether a speaker may be fabricating stories or experiencing stress. The complexity of language, including sentence length and the use of complex versus simple vocabulary, also provides clues about a speaker's cognitive burden, which often increases with deception or uncertainty.

Changes in speech patterns, such as abrupt shifts in vocabulary or sentence structure, can indicate stress or deceptive behavior. Sentiment analysis further aids in understanding the speaker's underlying emotions and attitudes by assessing whether the tone of the speech is positive, negative, or neutral, which is crucial for gauging sincerity and emotional states. The frequency and distribution of linguistic fillers like “um,” “uh,” or “like,” as well as hesitations, often signal nervousness, lack of preparation, or deceit.

Moreover, anomalies in syntax and grammar, such as errors or unusual sentence constructions, can suggest cognitive stress potentially linked to dishonesty or emotional distress. The analysis of response latency and the length of responses shed light on the cognitive processes involved, varying with the truthfulness or emotional involvement of the speaker. Consistency of statements over time or within a single speech helps identify contradictions or fabrications, providing further evidence of a speaker's reliability.

Additionally, the use of personal pronouns can reveal much about a speaker's level of engagement, emotional distance, or deception, while modal words expressing likelihood or certainty, such as “must,” “might,” or “could,” offer insights into the speaker's confidence and the veracity of their statements. Together, these textual features provide a comprehensive toolset for analyzing speech, enabling a deeper understanding of a speaker's intent, reliability, and emotional state.

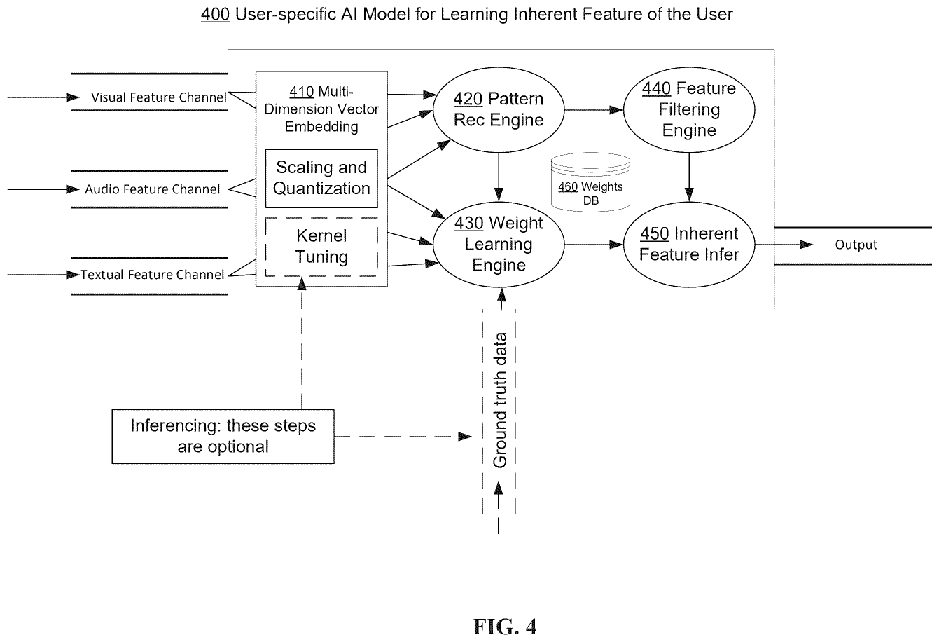

FIG. 4 illustrates a block diagram of an inherent subject feature extraction model, in accordance with some embodiments. This block diagram in FIG. 4 provides some example details of the AI system described in FIGS. 1-3 for learning inherent subject features.

As shown, the subject-specific AI model 400 for learning inherent features of a subject may include a plurality of internal components, including a multi-dimension vector embedding layer 410, an pattern recognition engine 420 for recognizing the value distribution of the explicit subject features, a weight set learning engine 430, a feature filtering engine 440 for filtering insignificant (repetitive or inconsequential) explicit subject features received from various feature channels (e.g., visual feature channel, audio feature channel, textual feature channel), and a weight learning engine 430 for (1) learning proper weights to assign to the explicit subject features in order to generate a predicted inherent subject feature that approximates the ground truth data (during training), and (2) dynamically adjusting the weights assigned to the explicit subject features based on live ground truth data (during inferencing), and an inherent feature prediction engine 450 learned to find the optimal hyperplane for classifying the input features into multiple classes, i.e., possible values of the inherent subject feature.

In some embodiments, the multi-dimension vector embedding layer 410 is configured to unify the different data formats of the explicit subject features received from different feature channels. As discussed above, the visual features such as pixel intensity pattern or color distribution pattern may have different feature representations than the word embeddings of the textual features. The multi-dimension vector embedding layer 410 may perform scaling to these explicit values such that the feature values are within the same value space. It may also perform quantization to reduce the computational complexity and enhance the model's efficiency by converting continuous features into a finite set of discrete values. This step is crucial for handling large volumes of data efficiently and effectively, ensuring that the downstream models (e.g., the SVM or decision trees) can process these features in a more streamlined and computationally feasible manner, which is particularly important when deploying models in environments with limited processing power or when real-time processing is required.

In addition, kernel tuning (specific to SVM models) may be performed to deal with diverse input features from different domains or feature spaces, such as those combining textual, visual, and auditory data. After selecting a proper kernel function (e.g., linear kernel, polynomial kernel, radial basis function (RBF), and sigmoid kernel) for the SVM, it may project the nonlinear and complex relationships among the received explicit subject features into a higher-dimensional space, thereby uncovering patterns that are apparent in the original space. In some embodiments, explicit subject features from different feature channels may use different kernels because they present different feature value distributions.

While FIG. 1 describes various embodiments of the AI system for inferring inherent subject feature based on explicit subject features, the combination of the pattern recognition engine 420, weight learning engine 430, feature filtering engine 440, and inherent feature inference engine 450 in FIG. 4 provides another embodiment of such AI system.

For example, given the substantial number of explicit subject features that can be derived from a video source, it presents a technical challenge to deploy an efficient SVM that processes these features without significant computational delays and extensive demands on hardware resources. To address these technical challenges, in some embodiments, the pattern recognition engine 420 incorporates a pattern classification model, such as a deep neural network, which is trained to cluster certain explicit subject features and discern the value distribution pattern within these clusters. Consequently, this value distribution pattern serves as the input for the subsequent SVM, instead of the individual explicit subject features. This strategy significantly decreases the number of inputs to the SVM by several folds. Additionally, in some embodiments, the pattern recognition engine 420 may categorize similar features together.

For instance, features associated with happiness, such as lifted corners of the mouth, crow's feet at the eyes, and raised cheeks, often appear simultaneously during genuine smiles and can be grouped to indicate the emotion of happiness effectively. As another example, sadness is typically expressed through raised inner corners of the eyebrows, downturned mouth corners, and slightly drooping eyelids, which together convey a somber demeanor. The pattern recognition engine 420 will group these features together and generate an intermediate subject feature, as an input to the SVM for inferring the overall inherent subject feature.

During this grouping and pattern-recognizing process, some features would be considered repetitive (suggesting the same intermediate subject feature) or inconsequential (does not contribute to any intermediate subject feature). The feature filtering engine 440 will filter out these features to further prune down the number of inputs for the SVM.

In addition, the weight learning engine 430 and the inherent feature inference engine 450 may refer to a pair of important components in the SVM. The weight learning engine 430 may be trained to learn the assignment of weights to the intermediate subject features generated from the pattern recognition engine 420, and the inherent feature inference engine 450 may be trained to find the hyperplane to classify the weighted input features, such that the classification result (i.e., the inferred inherent subject feature) is close the ground truth data (i.e., the observed/verified inherent subject feature).

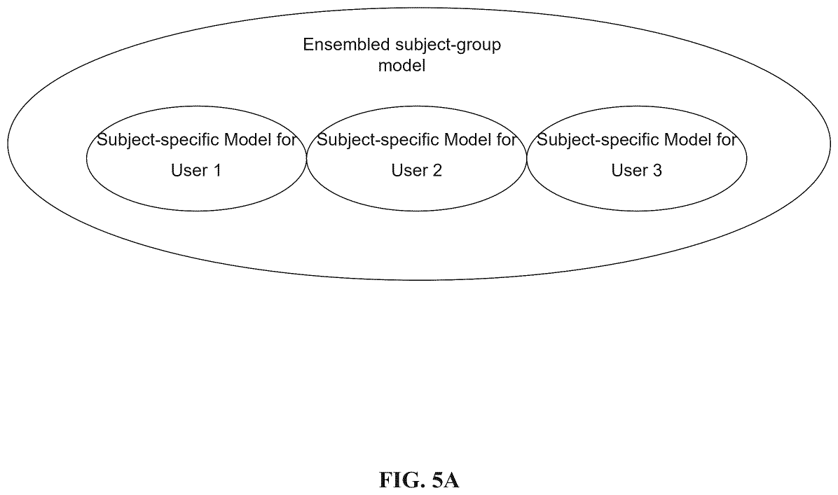

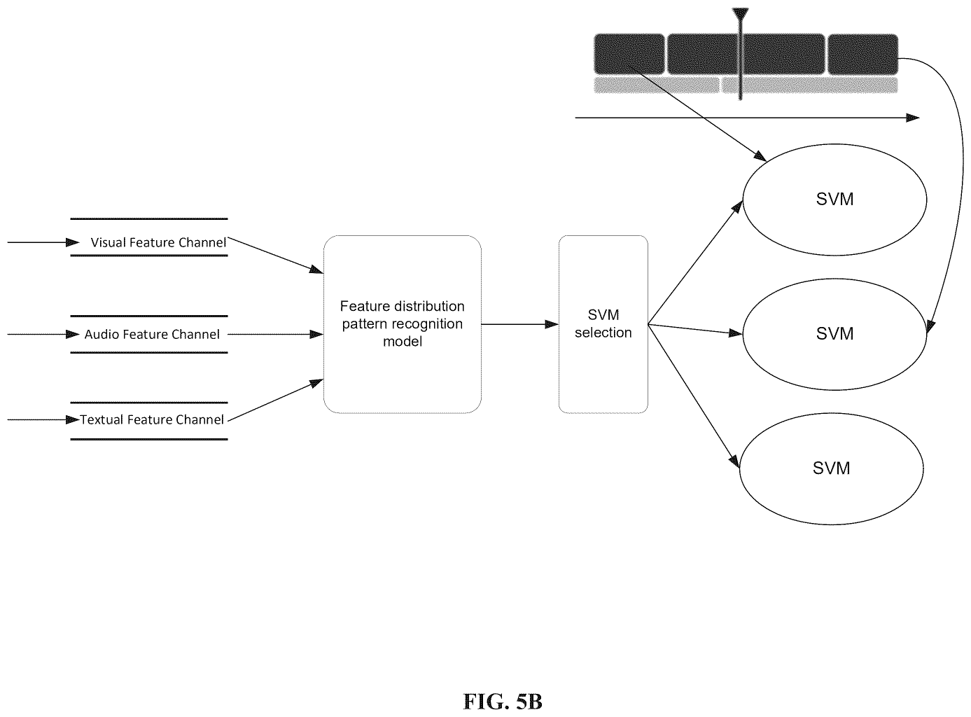

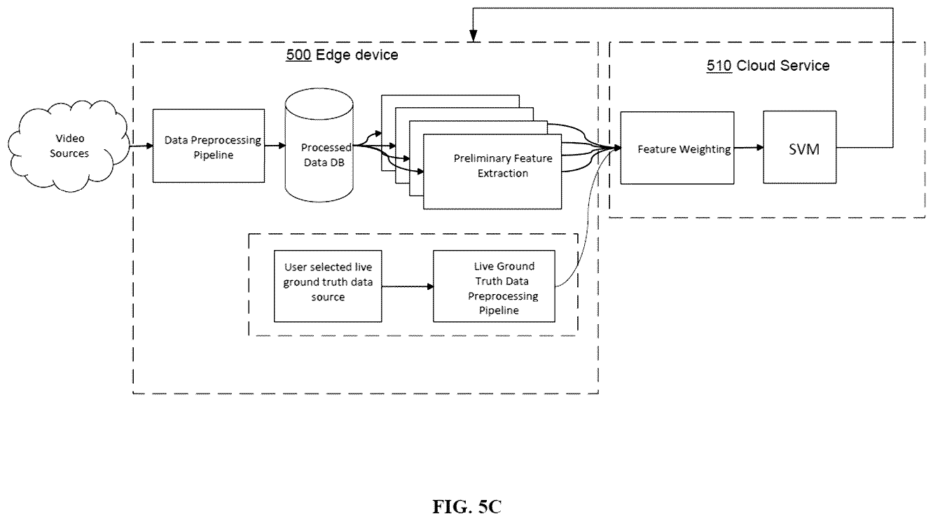

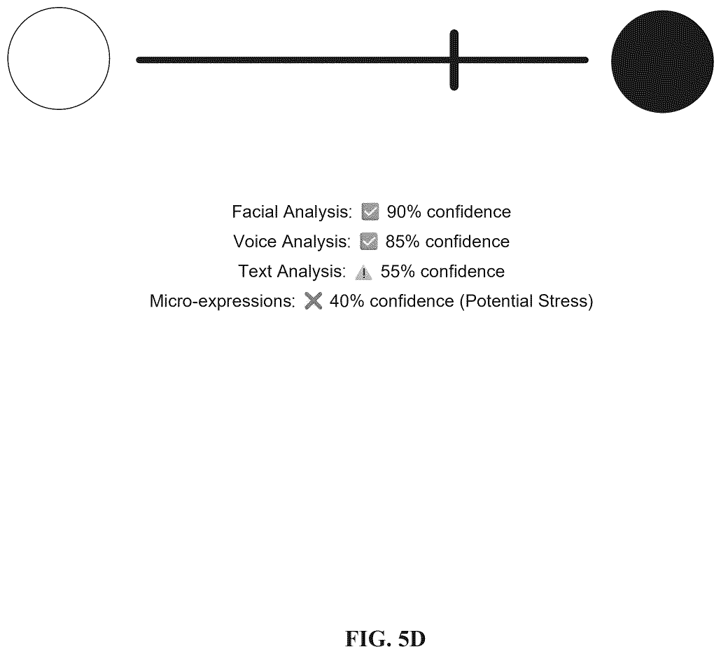

FIGS. 5A and 5B illustrate two examples of enhanced versions of the inherent subject feature extraction model, in accordance with some embodiments.

The AI system described previously is tailored to individual subjects, specifically using video sources and ground truth data from a single subject to train the model to predict that particular subject's inherent features. However, maintaining and deploying subject-specific models can be complex and sometimes unnecessary, especially since many subjects exhibit high levels of similarity. In such instances, AI models for subjects who share similar characteristics can be combined to create a subject-group AI model, as shown in FIG. 5A. This consolidated model can then be applied to any subject within that group. In some embodiments, the process of identifying similar subjects is based on the historical inferences made by the subject-specific AI models. For example, if consistent predictions of the same inherent features are made based on similar explicit subject features from two different subjects, these subjects might be considered sufficiently similar to be grouped together and use the same AI model.

FIG. 5B illustrates an embodiment in which different SVM models may be activated at different points during the playback or livestreaming of a subject's video. This approach is designed to accommodate scenarios in which a subject exhibits different inherent features in different sections of the video, such as when responding to various questions or discussing different topics. In these instances, a feature distribution pattern recognition model is utilized to track changes in the explicit subject features. When a change in the pattern of explicit features is detected, a corresponding SVM is activated. These multiple SVMs are pre-trained, subject-specific AI models that are each tailored to infer the subject's inherent features under distinct circumstances. Essentially, a subject may have several SVMs, each trained to assess their inherent features in varying situations.

FIG. 5C illustrates an example architecture for deploying the inherent subject feature learning model, in accordance with some embodiments. The example architecture includes deploying the inherent subject feature learning model using edge computing devices 500 in conjunction with cloud-based services 510. This architecture leverages edge computing to distribute computational tasks efficiently, minimizing centralized resource bottlenecks and improving real-time responsiveness.

As depicted, a subject interacts with an edge device such as a personal computer, smartphone, or tablet to view video content, including live streams or recorded videos. The edge device is equipped with sufficient computational resources to execute preliminary feature extraction tasks, significantly reducing the data transmitted to the cloud. Specifically, the edge device performs spatial and temporal feature extraction by processing visual, audio, and textual streams locally.

In some embodiments, the edge device 500 may implement a video data preprocessing pipeline that separates the video stream into visual, audio, and textual data. Visual frames are processed using local computer vision algorithms to extract spatial features such as facial landmarks, micro-expressions, eye movements, pupil dilation, and body postures. Temporal features capturing dynamic behaviors and changes in expressions are extracted through lightweight temporal convolutional networks (TCN) or recurrent neural network (RNN) models optimized for edge computing environments. Similarly, audio data extracted at the edge is processed using audio feature extraction models employing techniques such as Short-Time Fourier Transform (STFT) and Mel-Frequency Cepstral Coefficients (MFCCs) to identify vocal characteristics including tone, pitch, speech rate, and prosodic variations. Concurrently, textual data is generated from the audio stream through edge-optimized Automatic Speech Recognition (ASR) engines, providing immediate linguistic feature extraction and pattern analysis.

The “real-time” prediction requirement is important for the use cases. Therefore, to further optimize real-time performance, the edge device 500 may incorporate a two-stage classification mechanism that enhances efficiency while maintaining high prediction accuracy. For example, after feature extraction, the edge device 500 applies a lightweight SVM (e.g., the lightweight SVM is preinstalled or deployed on the edge device 500) to perform preliminary classification of the subject's inherent attributes. If the confidence score of this local SVM surpasses a predefined threshold, indicating that the subject's features closely match a known pattern (e.g., a stable emotional state or a frequently observed gesture), the edge device can return a prediction immediately, without querying the cloud 510. This ensures ultra-low latency responses for cases where the system has high confidence in the inference.

For cases where the confidence level is below the threshold, or where the subject exhibits unfamiliar or complex behavior patterns, the edge device 500 forwards the filtered and synchronized temporal-spatial feature data—including micro-expressions, physical gestures, voice dynamics, and textual features—to the cloud 510 for refined classification. The cloud-based SVM, with its greater computational power and larger set of parameters, performs advanced analysis to generate final inferences.

Here, the lightweight SVM deployed on the edge device may be derived from the heavyweight SVM model hosted on the cloud. The heavyweight SVM is a full-scale, high-dimensional classifier trained on a large dataset, incorporating a wide range of explicit features extracted from multimodal inputs such as visual, audio, and textual streams. However, deploying this full-scale model directly on edge devices is often computationally expensive and impractical due to constraints in processing power, memory, and energy efficiency. Therefore, a model compression pipeline may be used to generate the lightweight SVM from the heavyweight SVM while retaining essential decision-making capabilities.

In some embodiments, to reduce the computational burden on the edge device 500, feature selection is applied to the heavyweight SVM to remove unnecessary or redundant features before generating the lightweight model. The cloud-based SVM analyzes the contribution of each feature to classification accuracy using Recursive Feature Elimination (RFE). During this process, the cloud-based system iteratively removes less significant features and retrains the model, identifying the minimal set of features necessary for robust classification until the weights of the remaining features are all above a threshold. Additionally, Principal Component Analysis (PCA) may be applied to transform the feature space, preserving the most informative feature variations while reducing dimensionality. The result is a feature-reduced model that maintains strong predictive performance while reducing input complexity for the edge device.

After feature selection, the dimensionality of the SVM model may further be reduced using decomposition and compression, e.g., Singular Value Decomposition (SVD) and autoencoder-based compression. The cloud-based SVM processes the support vectors and kernel functions, identifying patterns in the high-dimensional space. SVD decomposes the support vector matrices into smaller, lower-rank approximations, which allows the edge device 500 to operate on a compact representation of the decision boundaries while still achieving accurate classification. Autoencoder-based compression is applied to learn a compressed embedding of the original feature space, allowing the edge device to reconstruct essential classification features with reduced computational overhead.

In some embodiments, the generation of the lightweight SVM may be further refined using model distillation. The heavyweight SVM serves as a teacher model that provides decision boundaries and classification outputs to train a smaller student SVM. The student SVM, designed for the edge device, is trained to approximate the same decision-making patterns as the teacher model but with fewer support vectors and a simplified kernel function. During training, the cloud-based model fine-tunes the parameters of the student SVM to ensure that it mirrors the performance of the heavyweight SVM while being optimized for real-time inference. Support vector pruning is then applied to remove redundant or less influential support vectors, which further reduces the complexity of the model while maintaining accurate classification. Additionally, quantization may be used to convert floating-point calculations in the SVM model into lower-bit representations such as INT8, allowing for efficient computations on resource-constrained edge devices.

Once generated, the lightweight SVM may be periodically synchronized and updated with the cloud-based heavyweight SVM. Instead of replacing the entire model, the cloud-based system sends incremental updates, adjusting support vectors and modifying decision boundaries based on newly encountered data. The edge device maintains real-time adaptability by incorporating these updates with minimal bandwidth consumption. If the edge device repeatedly encounters classification scenarios where confidence is low, it can request a retraining session from the cloud. In response, the heavyweight SVM refines its training on the new data and generates an updated lightweight SVM that is then deployed to the edge device. This process ensures that the lightweight SVM remains aligned with the evolving classification needs while maintaining efficiency for real-time inference.

FIG. 5D illustrates an example UI for presenting the predicted result of the inherent subject feature learning model, in accordance with some embodiments. The UI is designed to provide a clear, intuitive, and real-time visualization of the system's prediction regarding the truthfulness or credibility of a speaker.

As shown in FIG. 5D, rather than relying on a binary classification of “true” or “false,” the UI implements a Live Truthfulness Gauge, which presents a dynamic, continuum-based confidence score reflecting the likelihood that the speaker is being truthful.

In some embodiments, the Live Truthfulness Gauge is a color-coded, real-time moving indicator that shifts dynamically as the person speaks. The gauge operates along a spectrum where green represents a high confidence in truthfulness, yellow signifies uncertainty, and red suggests a higher likelihood of deception. This design allows decision-makers to interpret nuances in the speaker's behavior rather than depending on an oversimplified true/false result. As the speaker continues speaking, the gauge continuously updates, responding to fluctuations in vocal tone, facial expressions, and linguistic patterns. This real-time update mechanism ensures that the subject is not presented with a static prediction but instead a progressive assessment that evolves throughout the conversation.

In some embodiments, the Live Truthfulness Gauge may be accompanied with additional data to further enhance interpretability and trust. For example, the UI may also include a modal breakdown of key contributing factors that influence the truthfulness score. The contributing factors are derived from multimodal inputs, each analyzed to provide a transparent justification for the prediction. Facial analysis evaluates micro-expressions, eye movements, and facial tension, detecting subtle cues that may indicate stress or confidence. Vocal prosody is examined by analyzing speech rate, pitch stability, and pauses, which can signal hesitation or vocal stress. Textual patterns are assessed by scrutinizing sentence structures, the presence of hesitation words, and contradictions that may emerge in speech. Body language is also taken into account by tracking posture shifts, gestures, and other nonverbal behaviors associated with either confidence or deception. By presenting these breakdowns, the UI provides subjects with an intuitive explanation of how the system arrives at its prediction, ensuring transparency and facilitating further investigation when necessary.

Each of these components is displayed in a separate panel next to the Live Truthfulness Gauge, providing subjects with a transparent and explainable breakdown of how the system arrived at its prediction. If certain modalities contribute disproportionately to a low confidence score, the UI can highlight those aspects, allowing the subject to investigate further.

The UI is overlayed onto the video feed, displaying the predicted results in real-time as the speaker is observed. This ensures that the AI's inference remains tightly integrated with the subject's natural workflow, eliminating the need for manual cross-referencing between the prediction system and the recorded footage. By presenting the results in sync with the live or recorded video, the system provides immediate context to decision-makers, allowing them to take timely action based on the Al's insights.

A key improvement introduced by this UI design is its ability to provide continuous feedback rather than discrete labels, reducing misinterpretation and improving situational awareness. In traditional deception detection systems, binary outputs often lead to overreliance on a single momentary classification, whereas this system allows subjects to observe the evolving nature of a conversation and recognize patterns over time. Additionally, the real-time breakdown helps mitigate biases in automated decision-making by enabling human users to critically assess the factors influencing the AI's confidence score.

### Practical Applications

### 1. Law Enforcement

In the context of law enforcement and interrogation analysis, the AI system may be deployed to assist investigators in real-time assessment of a suspect's truthfulness during questioning. The system may leverage a combination of edge and cloud-based processing to ensure immediate feedback while maintaining accuracy through historical validation.

During an interrogation, the suspect's facial expressions, vocal intonations, micro-expressions, and body language may be continuously captured and processed using the AI system. The interrogation room or the officer's body camera may be equipped with an edge device that runs a lightweight SVM, which may provide an immediate preliminary classification based on multimodal feature extraction. This edge-based analysis may operate using a Live Truthfulness Gauge, a dynamic visualization that shifts in real-time based on the evolving behavioral cues of the suspect. The system may not rely on a binary output but instead may present a continuum-based confidence score, ensuring that investigators can interpret subtle fluctuations in truthfulness rather than making absolute determinations.

The edge device may preprocess video and audio inputs, performing spatial and temporal feature extraction to isolate facial micro-expressions, vocal stress patterns, and physiological indicators of stress. Facial analysis may detect involuntary muscle movements, gaze aversion, and tension-related changes in facial posture. Vocal prosody analysis may evaluate shifts in speech patterns, pitch, and hesitation markers that may indicate cognitive stress or deception. Textual analysis may transcribe and process speech in real-time, detecting inconsistencies in sentence structure and hesitation-filled responses. Body language detection may monitor unnatural posture shifts and gestures that are often linked to deceptive behavior. These explicit features may be processed and analyzed locally on the edge device, ensuring minimal latency and allowing officers to receive immediate insights while conducting the interrogation.

If the lightweight SVM on the edge device determines a high-confidence prediction, the investigator may be immediately notified through the UI overlay, which may present a real-time truthfulness gauge and a breakdown of contributing factors. However, if the system encounters an ambiguous case—such as a suspect exhibiting mixed behavioral cues or responses falling within an uncertainty range—the edge device may transmit the preprocessed, filtered, and synchronized feature data to the cloud-based heavyweight SVM for further analysis. The cloud-based model, trained on a significantly larger dataset of past interrogations and verified ground truth outcomes, may perform a more comprehensive evaluation by referencing historical deception patterns and forensic evidence correlations.

### 2. Public Announcements

In the context of financial market reactions to public announcements, the AI system may be deployed to analyze live or recorded speeches from key financial figures such as CEOs, Federal Reserve officials, or government spokespersons. The system may assess the speaker's sincerity, confidence, and credibility in real-time, allowing investors

The AI system may be implemented as a two-stage classification model, where an edge device may perform real-time analysis while a cloud-based model may refine and validate predictions based on historical data. The edge device, which may be integrated into financial news terminals, trading platforms, or investor dashboards, may execute lightweight processing of live-streamed speeches. It may capture explicit features such as facial micro-expressions that indicate hesitation or overconfidence, shifts in vocal tone and pitch that may signal uncertainty, and linguistic structures that may reveal hedging or misleading statements. These features may be processed locally by a lightweight SVM, which may generate an immediate prediction regarding the speaker's authenticity and confidence level. The results may be displayed using a Live Truthfulness Gauge, providing investors with a real-time, continuously updated confidence score rather than a binary classification.

If the edge device determines that the speaker's credibility assessment falls within an ambiguous range, it may transmit preprocessed, filtered, and synchronized feature data to the cloud-based heavyweight SVM for deeper analysis. The cloud-based model, trained on a vast repository of past financial announcements and their corresponding market reactions, may perform a more comprehensive evaluation by comparing the speaker's behavior and linguistic choices against historical patterns. By analyzing how similar statements have affected market trends in the past, the cloud model may refine the initial assessment and provide a more context-aware prediction of potential market shifts.

The system may integrate real-time market data feeds to correlate speech-based predictions with immediate financial indicators, such as stock price fluctuations, changes in volatility indices (e.g., VIX), and shifts in investor sentiment. If a speaker's statement is detected to have a high probability of triggering a market reaction, the system may issue alerts to investors, allowing them to adjust their trading strategies accordingly. Additionally, historical analysis conducted by the cloud-based SVM may help institutional investors refine risk models by identifying which behavioral cues from financial leaders have been historically associated with major market events.

### 3. Job Interview

In the context of job applicant evaluation for critical roles, the AI system may be deployed to assist HR professionals in assessing a candidate's sincerity, stress levels, and confidence during virtual interviews. This implementation may be particularly valuable for hiring in high-stakes positions such as senior executives, intelligence officers, and roles requiring security clearance.

The AI system may operate through a two-stage classification model, where an edge device may perform preliminary analysis while a cloud-based model may refine and enhance hiring accuracy through long-term data correlation. In a virtual interview, the candidate's facial expressions, vocal tones, micro-expressions, and speech patterns may be continuously captured and analyzed. The edge device, which may be the interviewer's computing device running an AI-powered video conferencing platform, may preprocess these inputs in real-time, using a lightweight SVM to classify confidence levels, sincerity indicators, and stress signals. The Live Truthfulness Gauge may provide immediate feedback, displaying a continuously updated confidence score rather than a binary assessment, allowing interviewers to observe dynamic behavioral changes throughout the conversation.

The system may analyze facial cues such as eye contact consistency, lip compression, and brow movements, which may indicate levels of confidence or nervousness. Vocal prosody analysis may capture changes in tone, speech rate, and hesitation markers that may suggest uncertainty or cognitive stress. Linguistic analysis may examine response structures, detecting patterns such as excessive hedging, overuse of qualifiers, or contradictions in responses that may indicate a lack of confidence in the provided answers. Additionally, body language detection may assess posture shifts, hand movements, and physical tension, contributing to a holistic evaluation of the candidate's composure.

If the edge device determines that a candidate's behavioral responses exhibit high confidence and alignment with known success traits, an immediate positive assessment may be displayed. However, if uncertainty is detected or behavioral patterns suggest inconsistency, the system may transmit preprocessed, filtered, and synchronized feature data to the cloud-based heavyweight SVM for deeper analysis. The cloud model, trained on a vast dataset of past interviews and validated hiring outcomes, may compare the candidate's behavioral patterns to historical records of successful and unsuccessful hires. By leveraging long-term post-hire performance metrics, reference checks, and retention data, the cloud model may refine its predictions and provide HR professionals with more context-aware insights into the candidate's likelihood of success in the role.

FIG. 6 illustrates an example computing device in which any of the embodiments described herein may be implemented. The computing device 600 may be used to implement one or more components of the systems and the methods shown in FIGS. 1-5 The computing device 600 may comprise a bus 602 or other communication mechanism for communicating information and one or more hardware processors 604 coupled with bus 602 for processing information. Hardware processor(s) 604 may be, for example, one or more general purpose microprocessors.

The computing device 600 may also include a main memory 608, such as a random-access memory (RAM), cache and/or other dynamic storage devices, coupled to bus 602 for storing information and instructions to be executed by processor(s) 604. Main memory 608 also may be used for storing temporary variables or other intermediate information during execution of instructions to be executed by processor(s) 604. Such instructions, when stored in storage media accessible to processor(s) 604, may render computing device 600 into a special-purpose machine that is customized to perform the operations specified in the instructions. Main memory 608 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, or networked versions of the same.

The computing device 600 may implement the techniques described herein using customized hard-wired logic, one or more ASICs or FPGAs, firmware and/or program logic which in combination with the computing device may cause or program computing device 600 to be a special-purpose machine. According to one embodiment, the techniques herein are performed by computing device 600 in response to processor(s) 604 executing one or more sequences of one or more instructions contained in main memory 608. Such instructions may be read into main memory 608 from another storage medium, such as storage device 609. Execution of the sequences of instructions contained in main memory 608 may cause processor(s) 604 to perform the process steps described herein. For example, the processes/methods disclosed herein may be implemented by computer program instructions stored in main memory 608. When these instructions are executed by processor(s) 604, they may perform the steps as shown in corresponding figures and described above. In alternative embodiments, hard-wired circuitry may be used in place of or in combination with software instructions.

The computing device 600 also includes a communication interface 610 coupled to bus 602. Communication interface 610 may provide a two-way data communication coupling to one or more network links that are connected to one or more networks. As another example, communication interface 610 may be a local area network (LAN) card to provide a data communication connection to a compatible LAN (or WAN component to communicate with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be compromised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The terms “include” or “comprise” are used to indicate the existence of the subsequently declared features, but do not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method for training a user-specific machine learning model to inferencing an inherent feature from explicit video data of a subject, comprising:
receiving, by a computing system comprising at least one processor, video data of the subject, wherein the video data comprises audio data and visual data of the subject, and the video data is either recorded or live streamed;
preprocessing, by a video data preprocessing pipeline executed by the computing system, the video data to separate the audio data and the visual data into respective independent data channels, wherein the preprocessing comprises: extracting video frames from the visual data, and extracting audio segments from the audio data;
inputting the video frames and the audio segments into a plurality of pre-trained feature extraction machine learning models for generating a plurality of channels of feature embeddings, respectively;
obtaining ground truth data associated with the inherent feature of the subject, wherein the ground truth data is either historical ground truth data when the video data is recorded, or estimated ground truth data when the video data is live streamed;
training a subject-specific machine learning model based on the plurality of channels of feature embeddings and the ground truth data, wherein the training comprises:
assigning weights to the plurality of channels of feature embeddings;
generating a plurality of predicted values of the inherent feature of the subject respectively based on the plurality of channels of feature embeddings;
generating a weighted value of the inherent feature of the subject based on the weights and the plurality of predicted values; and
training the subject-specific machine learning model by adjusting weights, thereby minimizing an error between the weighed value of the inherent feature of the subject and the ground truth data;
deploying the plurality of pre-trained feature extraction machine learning models and the trained subject-specific machine learning model for inferencing the inherent feature of the subject based on other video data of the subject.

2. The computer-implemented method of claim 1, wherein the plurality of pre-trained feature extraction machine learning models comprises:
a first machine learning model for generating a channel of textual content extracted from the audio data;
a second machine learning model for generating a channel of verbal features extracted from the audio data; and
a third machine learning model for generating a channel of visual features extracted from the visual data.

3. The computer-implemented method of claim 2, wherein the first machine learning model comprises:
a natural language processing model (NLP) for generating text content from the audio data.

4. The computer-implemented method of claim 2, wherein the second machine learning model comprises:
a verbal feature extraction model for extracting speech pattern features including tones, voice prosody, stutters, variations in pitch, speech rate, volume or intensity, or pauses.

5. The computer-implemented method of claim 2, wherein the third machine learning model comprises:
a visual feature extraction model for extracting facial expressions, micro expressions, physiological responses, eye-tracking, pupil dilations, thermal imaging, or body movements.

6. The computer-implemented method of claim 1, wherein the ground truth data comprises a verified value of the inherent feature of the subject in response to the video data of the subject.

7. The computer-implemented method of claim 1, wherein the subject-specific machine learning model comprises a Support Vector Machine (SVM), and the training the subject-specific machine learning model comprises:
creating a plurality of classes for the weighed value of the inherent feature of the subject in a high-dimensional feature space; and
adjusting the weights assigned to the plurality of channels of feature embeddings to find a hyperplane that separates the plurality of classes in the high-dimensional feature space and maximizes margins between classes.

8. The computer-implemented method of claim 1, wherein the inherent feature of the subject comprises one of credibility, consistency, authenticity, bias, veracity, truthfulness.

9. The computer-implemented method of claim 2, wherein the plurality of predicted values of the inherent feature of the subject generated respectively based on the plurality of channels of feature embeddings comprises:
a predicted value of the inherent feature of the subject generated solely based on the channel of audio features; and
a predicted value of the inherent feature of the subject generated solely based on the channel of visual features.

10. The computer-implemented method of claim 1, wherein:
the video data includes recordings of the subject's past speeches, and the historical ground truth data comprises real-world outcomes observed following these speeches, or
the video data comprises the subject's live speech, and the ground truth data comprises real-time market reactions captured by market indices.

11. The computer-implemented method of claim 1, wherein the training of the subject-specific machine learning model comprises:
segmenting the video data into a plurality of video segments based on value distribution patterns of the plurality of channels of feature embeddings extracted from each of the plurality of video segments; and
training the subject-specific machine learning model to obtain a plurality of sets of weights respectively corresponding to the plurality of video segments, such that the subject- specific machine learning model applies different sets of weights for different video segments with different value distribution patterns.

12. The computer-implemented method of claim 1, further comprising:
obtaining a plurality of trained subject-specific machine learning models trained for a group of subjects sharing a number of characteristics;
aggregating the plurality of trained subject-specific machine learning models into a subject-group-specific machine learning model; and
deploying the subject-group-specific machine learning model for inferencing the inherent feature of the group of subjects based on video data of the group of subjects.

13. The computer-implemented method of claim 1, wherein the deploying the plurality of pre-trained feature extraction machine learning models and the trained subject-specific machine learning model for inferencing comprises:
deploying the plurality of pre-trained feature extraction machine learning models on an edge device to locally process the other video data and extract corresponding feature embeddings, wherein the extracted feature embeddings are sent to a cloud server hosting the subject-specific machine learning model;
deploying the subject-specific machine learning model on the cloud server for high-accuracy inferencing based on the extracted feature embeddings received from the edge device;
generating a lightweight version of the subject-specific machine learning model through knowledge distillation and model compression; and
deploying the lightweight version of the subject-specific machine learning model on the edge device to enable localized inferencing of the inherent feature.

14. The computer-implemented method of claim 13, further comprising:
synchronizing the lightweight version with the subject-specific machine learning model on the cloud server.

15. A system for training a subject-specific machine learning model to inferencing an inherent feature of a subject from explicit video data of the subject, the system comprising one or more processors configured to:
receive video data of the subject, wherein the video data comprises one or more of audio data or visual data of the subject, and the video data is either recorded or live streamed;
input the video data of the subject into a plurality of pre-trained feature extraction machine learning models for generating a plurality of channels of feature embeddings, respectively;
obtain ground truth data associated with the inherent feature of the subject, wherein the ground truth data is either historical ground truth data when the video data is recorded, or estimated ground truth data when the video data is live streamed;
train a subject-specific machine learning model based on the plurality of channels of feature embeddings and the ground truth data, wherein the training comprises:
assigning weights to the plurality of channels of feature embeddings;
generating a plurality of predicted values of the inherent feature of the subject respectively based on the plurality of channels of feature embeddings;
generating a weighted value of the inherent feature of the subject based on the weights and the plurality of predicted values; and
training the subject-specific machine learning model by adjusting weights, thereby minimizing an error between the weighed value of the inherent feature of the subject and the ground truth data; and
deploy the plurality of pre-trained feature extraction machine learning models and the trained subject-specific machine learning model for inferencing the inherent feature of the subject based on other video data of the subject.

16. The system of claim 15, wherein to deploy the plurality of pre-trained feature extraction machine learning models and the trained subject-specific machine learning model, the one or more processors are further configured to:
deploy the plurality of pre-trained feature extraction machine learning models on an edge device to locally process video data and extract feature embeddings in real-time, wherein the extracted feature embeddings are sent to a cloud server hosting the subject-specific machine learning model;
deploy the subject-specific machine learning model on the cloud server for high-accuracy inferencing based on the extracted feature embeddings received from the edge device;
generate a lightweight version of the subject-specific machine learning model through knowledge distillation and model compression; and
deploy the lightweight version of the subject-specific machine learning model on the edge device to enable localized inferencing of the inherent subject feature without or before relying on continuous cloud access.

17. The system of claim 16, wherein the one or more processors are further configured to:
synchronize the lightweight version with the subject-specific machine learning model on the cloud server.

18. The system of claim 15, wherein the plurality of pre-trained feature extraction machine learning models comprises:
a first machine learning model for generating a channel of textual content extracted from the audio data;
a second machine learning model for generating a channel of verbal features extracted from the audio data; and
a third machine learning model for generating a channel of visual features extracted from the visual data.

19. The system of claim 18, wherein the second machine learning model comprises a verbal feature extraction model for extracting speech pattern features including tones, voice prosody, stutters, variations in pitch, speech rate, volume or intensity, or pauses.

20. The system of claim 18, wherein the third machine learning model comprises a visual feature extraction model for extracting facial expressions, micro expressions, physiological responses, eye-track, pupil dilations, thermal imaging, or body movements.
